(19) United States
(12) Patent Application Publication
(10) Pub. No.: US 2006/0230049 A1
(43) Pub. Date: Oct. 12, 2006

(54) Method and apparatus for selecting preferred images for a current exam based on a previous exam

(75) Inventors: Vijaykalyan Yeluri, Sunnyvale, CA (US); Denny Lau, Sunnyvale, CA (US); Eric Feingold, Philadelphia, PA (US); Mohan Naidu, Schaumburg, IL (US); Richard Yarger, Berkeley, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/104,249

(22) Filed: Apr. 12, 2005

(51) Int. Cl. G06F 7/00; G06F 17/00

(52) U.S. Cl. 707/100

(57) ABSTRACT

Certain embodiments of the present invention provide a system and method for interpreting images. An image acquisition device, such as a computerized tomography (CT) system, an ultrasound system, an electron beam tomography (EBT) system, a magnetic resonance (MR) system and the like, generates images and image sets, including a first image set and a second image set. A user may select notable images from the first image as significant images. Image content registration software identifies the contents of the significant images and the contents of the second image set. The contents may be anatomical contents. The contents of the significant images are compared to the contents of the second image set. Images from the second image set having contents corresponding to contents of the significant images are selected as preferred images. The preferred images may be labeled and displayed to a user.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to a system and method for improved medical imaging. Particularly, the present invention relates to a more efficient system and method for interpreting medical images.

Medical diagnostic imaging systems encompass a variety of imaging modalities, such as x-ray systems, computerized tomography (CT) systems, ultrasound systems, electron beam tomography (EBT) systems, magnetic resonance (MR) systems, and the like. Medical diagnostic imaging systems generate images of an object, such as a patient, for example, through exposure to an energy source, such as x-rays passing through a patient, for example. The generated images may be used for many purposes. For instance, internal defects in an object may be detected. Additionally, changes in internal structure or alignment may be determined. Fluid flow within an object may also be represented. Furthermore, the image may show the presence or absence of objects in an object. The information gained from medical diagnostic imaging has applications in many fields, including medicine and manufacturing.

As medical imaging has become more routine in the practice of healthcare professionals, it is increasingly common for an individual patient to have multiple imaging scans. Patients deemed high risk for specific medical ailments or patients undergoing therapy may have periodic scans to treat or prevent an ailment or disease. The image sets generated during each scan may be stored electronically. To realize the full benefit of the information gathered from multiple imaging sessions, it would be highly desirable to utilize information obtained from previous scans to interpret subsequent scans.

Currently, the interpretation of subsequent scans is highly inefficient. Because subsequent scan sessions often have a targeted element for which the scan is performed, many of the images generated in subsequent scans are not relevant for diagnosis or treatment. A healthcare professional, however, generally has to spend a significant amount of time filtering through the non-relevant images to locate the relevant images. In order to make the interpretation of subsequent scans more efficient, it would be highly desirable to identify the images relevant to a particular diagnosis or treatment while minimizing the exposure of the user to non-relevant material.

Therefore, there is a need for a system and method which minimizes the time of interpretation for subsequent scans based on information available from previous scans.

### SUMMARY OF THE INVENTION

Certain embodiments of the present invention provide a system and method for interpreting images. In an embodiment, an image acquisition device generates a plurality of image sets, including a first image set and a second image set. A user may use a user interface unit to select significant images from the first image set. A control unit may compare the content of the significant images with the content of images from the second image set. The control unit may also select images from the second image set having corresponding content to the significant images. The content may be anatomical content. The selected images may be labeled as preferred images. The first image set and second image set may be displayed to a user and the significant images and the preferred images identified.

In an embodiment, a plurality of images are formed during a first acquisition. The plurality of images form a first image set. The first image set has images selected as being significant. The first image set and image information may be stored for subsequent use. A second acquisition forms a second image set. The existence of the first acquisition is then recognized and the significant images from the first acquisition are identified. The content of the significant images and second image set is registered. The content of the second image set is then compared with the content of the significant images. The content may be anatomical content. Images from the second image set having content corresponding to content of the significant images are selected. In an embodiment, the selected images are labeled as preferred images and the first image set and second image set are displayed for a user with the significant images and preferred images identified.

Certain embodiments of a computer-readable storage medium include a set of instructions for a computer. The set of instructions includes a first selection routine for selecting significant images from a first image set. The set of instructions also includes a comparison routine for comparing contents of the significant images with the content of images from a second image set. The set of instructions also includes a second selection routine for selecting images from the second image set having content corresponding to the content of the significant images. In an embodiment, the set of instructions includes a registration routine for registering image content of the significant images and the second image set. The set of instructions may also include a label routine for labeling images selected from the second image set as preferred images.

### BRIEF DESCRIPTION OF THE DRAWINGS

FIG. 1 illustrates a system for interpreting images in accordance with an embodiment of the present invention.

FIG. 2 illustrates an embodiment of the system as shown in FIG. 1.

FIG. 3 illustrates a method for interpreting images in accordance with an embodiment of the present invention.

### DETAILED DESCRIPTION OF THE INVENTION

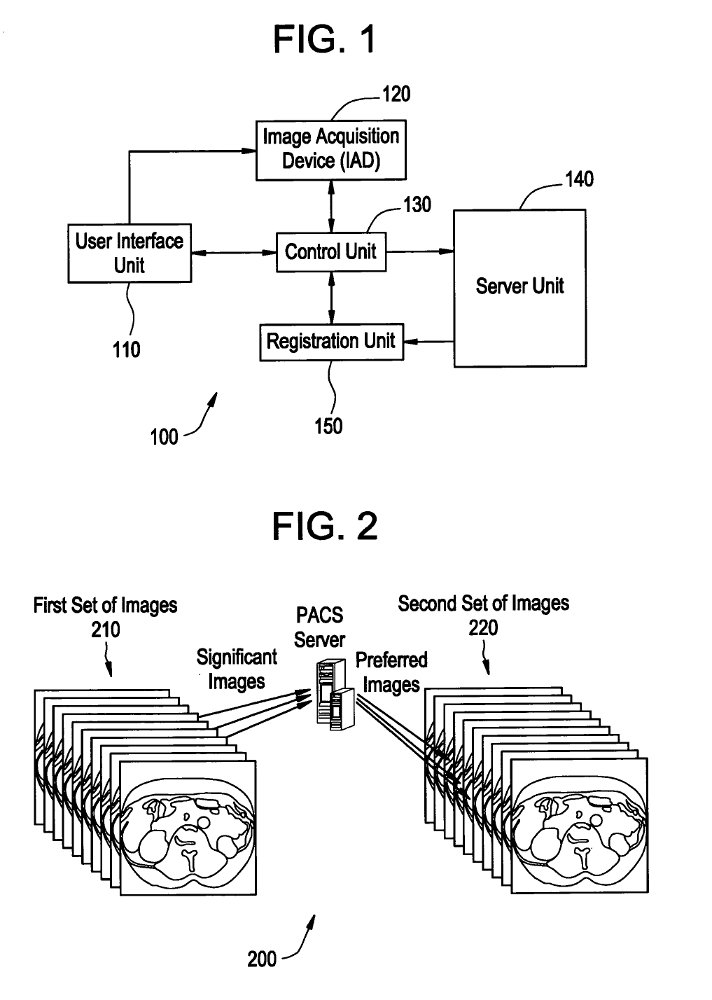

FIG. 1 illustrates a system 100 for interpreting images in accordance with an embodiment of the present invention. The system 100 includes a user interface unit 110 for communicating with a user. The user interface unit 110 may acquire and/or process user commands as well as present information to a user. The user interface unit 110 is in electrical communication with the control unit 130 and image acquisition device 120 (“IAD 120”). The control unit 130 controls operations of the system 100. The control unit 130 is in electrical communication with the IAD 120, a registration unit 150, and a server unit 140. The IAD 120 acquires and generates images and/or image data for processing. The registration unit 150 executes image content software which identifies various content shown in an image. The server unit 140 stores, processes, and/or operates on images generated by the IAD 120 and/or other data available to the system 100. The components of the system 100 may be single units, separate units, may be integrated in various forms, and may be implemented in hardware and/or in software.

The user interface unit 110 may be used for communicating with a user. As is explained further below, the communication includes acquiring and/or processing commands from a user, selecting significant images from a first image set, as well as presenting information to a user. In an embodiment, the user interface unit 110 may be a computing device with one or more devices to acquire commands from a user, and one or more devices to present information to a user. For example, the computing device may be a typical personal computer, notebook computer, personal digital assistant, or other computer unit. Typical devices used to acquire commands from a user may be a computer mouse, a computer keyboard, and/or a microphone. Typical devices used to present information to a user may be a display unit or speakers.

The control unit 130 generally controls operations in the system 100. Such operations include data processing and communications. The control unit 130 receives user commands from the user interface unit 110 and coordinates operations of the IAD 120, the registration unit 150, and the server unit 140. The control unit 130 may also receive image sets from the IAD 120. The control unit 130 may perform operations and/or present the image set to a user through the user interface 110. The control unit 130 may also communicate the image set to the server 140 unit and/or the registration unit 150 for storage and/or processing.

The IAD 120 acquires and processes images and image sets, including a first image set and a second image set, each image set having images. The images may be two or three-dimensional, and are generally images of the type generated by any medical diagnostic imaging device, including x-ray devices, computerized tomography (CT) devices, ultrasound devices, electron beam tomography (EBT) devices, magnetic resonance (MR) devices, and the like. The images and image sets may be communicated to the control unit 130 for processing and distribution.

The registration unit 150 executes image content registration software. The image content registration software may be used to identify the content shown in images. In an embodiment, the registration unit may execute image content registration software for identifying the anatomical content shown in the images. The image content registration software may use image intensity values or shape recognition to extract content from a volumetric set of images. For example, if a first set of images illustrates the content of a human liver, the image content registration software may identify the content of those images as illustrating a human liver. Moreover, the content may be compared to other volumetric sets of images. For example, the content of a first set of images may be compared to the content of a second set of images.

The server unit 140 generally stores, processes, and/or operates on the data available to the system 100. Image sets acquired by the IAD 120 may be communicated to the control unit 130. The control unit 130 may communicate the image sets and associated image information to the server unit 140 for processing or storage. The control unit 130 may also retrieve data stored on the server unit 140 for processing, or may instruct the server unit 140 to process data. The server unit 140 may also be in communication with the registration unit 150. In an embodiment, the server unit 140 may be a picture archive communication system (PACS). Typically a PACS system is used for archiving images, as well as distributing and displaying images. PACS systems are commonly used in radiology departments to support image management. Several PACS systems are currently available, including PACS systems manufactured by General Electric Medical Systems, Siemens, Agfa, Fuji, and Philips.

In operation, a user may instruct the IAD 120 to perform a first acquisition. The first acquisition may be of a patient, for example Patient A. The user manipulates the user interface unit 110 to issue a command to the IAD 120 to perform an acquisition. The IAD 120 then generates the first image set by performing the first acquisition. The IAD 120 may then communicate the first image set to the control unit 130. The control unit 130 may process the first image set and communicate with the user interface unit 110 to present the first image set to a user. In an embodiment, the images may be displayed to a user on a display unit as part of the user interface unit 110. The user may interpret and/or manipulate the images using the user interface unit 110.

As the user interprets the first image set, the user may select images from among the first image set which illustrate notable information regarding the condition of the patient. The selected images may be selected for any number of reasons. For example, the selected images may pertain to a specific diagnosis, condition, ailment or anatomical content. In an embodiment, the images selected by a user from among the first image set are significant images. As a user interprets the first image set, the images selected as significant are recorded, for example by the control unit 130.

Once a user has finished interpreting the first image set, the control unit 130 may communicate the first image set, and associated information, including information regarding which images were selected as significant, to the server unit 140. In an embodiment, the server unit 140 may store the information for later retrieval and operation.

A subsequent, second acquisition, for example, of Patient A may be performed. The subsequent scan may be performed using the same user interface unit 110, control unit 130, IAD 120, and registration unit 150 as used for the first scan. The subsequent scan may also be performed using an user interface unit 110, control unit 130, IAD 120, and registration unit 150 other than those used in the first scan. Moreover, the subsequent scan may be performed at the same geographic location as the first scan or a different geographic location. In an embodiment, the server unit 140 is connected to a network, for example an Intranet or the Internet, which is connected to multiple user interface units 110, control units 130, IADs 120, and registration units 150. In an embodiment, the items may be located in a single hospital, or multiple hospitals. Data stored on the server unit 140, including the first image set, may be accessed and shared throughout the network.

Similar to above, the IAD 120 may generate a second image set by performing a second acquisition. The IAD 120 may then communicate the second image set to the control unit 130. Generally, the images from both the first and second image sets may have header information that describes the patient and the scans. Once the images from the second image set are received, the control unit 130 may use header information to determine whether the patient has had a previous scan. In the ongoing example, the control unit 130 may examine the header information available as part of the second image set of Patient A and determine the existence of a first acquisition and first image set.

After the control unit 130 determines the existence of a first acquisition for Patient A, the control unit 130 may retrieve the first image set and associated information for the first acquisition. In an embodiment, the control unit 130 retrieves the first image set and associated information from the server unit 140. The retrieval may be local or over a network. The control unit 130 may then identify the significant images from the first image set. The control unit 130 may communicate the significant images to the registration unit 150 for processing.

In an embodiment, the registration unit 150 executes image content registration software. Image content registration software generally identifies the content illustrated in an image. For example, the registration unit 150 may execute image content registration software which identifies content of an image as anatomical structure. In such an example, the registration unit 150 may operate on the significant images to identify the anatomical content of the significant images. Once the registration unit 150 identifies the anatomical content of the significant images, the results are communicated to the control unit 130.

The second image set may then be communicated to the registration unit 150. The registration unit 150 may operate on the second image set to identify the anatomical content of the images contained in the second image set. Once the registration unit 150 identifies the anatomical content of the second image set, the results are communicated to the control unit 130.

In an embodiment, the control unit 130 compares the content of the significant images with the content of images from the second image set. Specifically, in an embodiment, the control unit 130 compares the anatomical content of the significant images from the first image set with the anatomical content of the second image set.

The control unit then selects images from the second image set having content corresponding to the content of the significant images. In an embodiment, the images selected from among the second image set are labeled as preferred images. For example, the preferred images are images from the second image set having anatomical content which corresponds to the anatomical content of the significant images from the first image set.

The control unit 130 may process the second image set, including the preferred images, and communicate with the user interface unit 110 to present the second image set to a user. In an embodiment, the second image set and preferred images may be displayed to a user on a display unit as part of the user interface unit 110. As the images are presented to a user, the preferred images may be labeled to obtain the user's attention. Accordingly, the anatomical content previously deemed important in a first examination may be presented as preferred content during the interpretation of a subsequent examination. Thus, a user may view images during a subsequent examination relevant to a particular diagnosis or treatment while minimizing the exposure of the user to non-relevant material.

In an embodiment, as the user interprets the preferred images as well as the remainder of the second image set, the user may mark new images as significant. Thus, in a third examination, the significant images from the second image set may be used to generate the preferred images of the third image set. Alternatively, the significant images from the first image set may be used to generate the preferred images of subsequent image sets. In an embodiment, a user may choose which image set to use to generate the preferred images of the current image set.

FIG. 2 illustrates an embodiment of the system 100 in which the control unit 130 and the registration unit 150 operate internal to the server unit 140. In an embodiment, the server unit 140 is a picture archive communication system (PACS server). The PACS server may communicate/operate on data acquired by the IAD 120. The PACS server may also receive data from and send data to the user interface unit 110. FIG. 2 also illustrates an example of a first set of images 210 and a second set of images 220. The user interface unit 110 and the IAD 120 are not shown in FIG. 2.

Once the first set of images 210 is acquired, the images 210 may be shown to a user in a similar manner as displayed in FIG. 2. A user may browse the first set of images 210 and determine which images should be marked as significant. The significant images may be labeled accordingly and communicated to the PACS server. After a second set of images 220 is acquired, the images 220 may be processed by the PACS server. The images of the second image set 220 having anatomical content corresponding to the anatomical content of the significant images of the first image set 210 are identified and labeled as preferred images. In an embodiment, the preferred images represent images which contain information previously deemed important. Therefore, a user may choose to view the preferred images prior to viewing the remainder of the images in the image set 220.

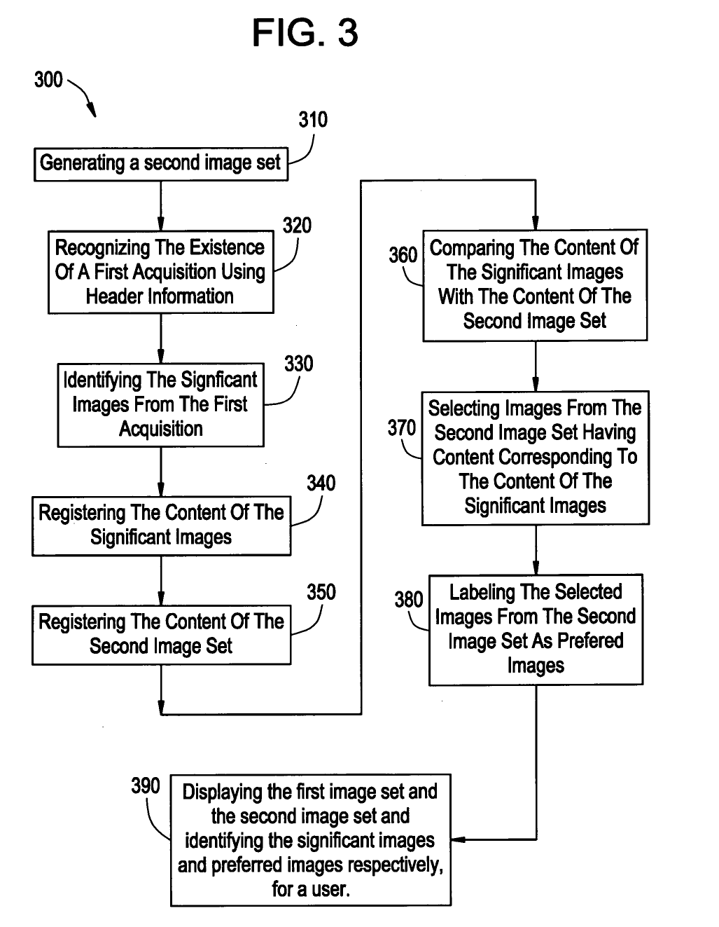

FIG. 3 illustrates a method 300 in accordance with an embodiment of the present invention. The method 300 presumes a first acquisition has previously been performed, and thus a first image set acquired, and significant images selected. In an embodiment, the images selected as significant images are labeled accordingly. The first image set, significant images, and associated information have presumably been electronically stored.

At step 310, a user has initiated a second acquisition and a second image set is generated. At step 320, the existence of the first acquisition is automatically recognized using header information. Alternatively, a user may disclose the existence of a first acquisition. At step 330, the significant images from the first acquisition are identified. At step 340, the contents of the significant images are registered. In an embodiment, registration is performed using image content registration software. Image content registration software generally identifies the content illustrated in an image. For example, the image content registration software may identify the content of an image as anatomical structure. In such an example, anatomical contents of the significant images are registered.

Next at step 350, the contents of the second image set are registered similar to the registration of the significant images, yielding the anatomical content of the second image set. At step 360, the anatomical contents of the significant images from the first image set are compared with the anatomical contents of the second image set. At step 370, images from the second image set having anatomical content corresponding to the anatomical content of the significant images are selected. The images selected from the second image set are labeled as preferred images at step 380. Finally, at step 390, the first image set and the second image set may be displayed with the significant images and preferred images respectively identified to a user.

The system and method described above may be carried out as part of a computer-readable storage medium including a set of instructions for a computer. The set of instructions includes a first selection routine for selecting significant images from a first image set. The set of instructions also includes a comparison routine for comparing content of said significant images with content of images from a second image set. The set of instructions also includes a second selection routine for selecting images from the second image set having corresponding content to the content of the significant images. The set of instructions may also include a registration routine for registering image content of the significant images and the second image set. The set of instructions may also include a label routine for labeling images selected from the second image set as preferred images. The content may be anatomical content.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims

1. A system for interpreting images, said system comprising:
an image acquisition device for acquiring a plurality of image sets, said plurality of image sets including a first image set and a second image set, said image sets having a plurality of images;
a user interface unit for communicating with a user, said communication including selecting significant images from said first image set;
a control unit for controlling operations, said operations including comparing contents of said significant images to contents of images from said second image set, and selecting images from said second image set having corresponding content to said significant images.

2. The system of claim 1, further comprising a registration unit for identifying content of said images.

3. The system of claim 1, wherein said contents are anatomical contents.

4. The system of claim 1, further comprising a server unit for storing said images and image information.

5. The system of claim 4, wherein said server unit is a picture archive communication server.

6. The system of claim 1, wherein said control unit labels images selected from said second image set as preferred images.

7. The system of claim 6, wherein the user interface unit includes a display unit for displaying said first image set and said second image set, said significant images and said preferred images being identified to a user.

8. The system of claim 1, wherein the control unit recognizes the existence of a first acquisition using header information.

9. The system of claim 8, wherein the control unit identifies the significant images from said first acquisition.

10. A method for interpreting images, a plurality of images forming an image set, including at least a first image set, said first image set having significant images, said method comprising:
comparing content of said significant images with content of images from a second image set; and
selecting images from said second image set having content corresponding with the content of said significant images.

11. The method of claim 10, wherein said content are anatomical content.

12. The method of claim 10, further comprising recognizing the existence of a first acquisition using header information.

13. The method of claim 12, further comprising identifying the significant images from said first acquisition.

14. The method of claim 10, further comprising registering the content of the significant images and registering the content of the second image set.

15. The method of claim 10, further comprising labeling the images selected from said second image set a preferred images.

16. The method of claim 15, further comprising displaying said first image set and said second image set, said significant images and said preferred images being identified to a user.

17. A computer-readable storage medium including a set of instructions for a computer, the set of instructions comprising:
a first selection routine for selecting significant images from a first image set;
a comparison routine for comparing content of said significant images with content of images from a second image set; and
a second selection routine for selecting images from the second image set having content corresponding to the content of the significant images.

18. The set of instructions of claim 17, further comprising a registration routine for registering image content of said significant images and said second image set.

19. The set of instructions of claim 18, wherein said content are anatomical content.

20. The set of instructions of claim 17, further comprising a label routine for labeling images selected from the second image set as preferred images.
